(19) United States
(12) Patent Application Publication
(10) Pub. No.: US 2010/0161614 A1
(43) Pub. Date: Jun. 24, 2010

(54) DISTRIBUTED INDEX SYSTEM AND METHOD BASED ON MULTI-LENGTH SIGNATURE FILES

(75) Inventors: Hyun Hwa CHOI, Daejeon (KR); Mi Young LEE, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/543,430

(22) Filed: Aug. 18, 2009

(30) Foreign Application Priority Data
Dec. 22, 2008 (KR) 10-2008-0131285

(51) Int. Cl. G06F 17/30

(52) U.S. Cl. 707/741; 707/E17.032; 707/E17.009; 707/E17.014

(57) ABSTRACT

A distributed index system and method based on multi-length signature files are provided. The distributed index system includes a feature vector extracting unit, a high-dimensional index unit, a high-dimensional index managing unit. The feature vector extracting unit extracts N-dimensional feature vectors from multimedia object and identifier. The high-dimensional index unit establishes a tree-based distributed index according to the identifier of the multimedia object and the N-dimensional feature vectors, and determines a signature length by comparing number of leaf nodes of the established distributed index tree and a reference cluster size. The high-dimensional index managing unit generates signatures for each leaf node, on which the determined length is reflected, and stores the generated signatures by matching with the N-dimensional feature vectors.

### CROSS-REFERENCE TO RELATED APPLICATIONS

This application claims priority under 35 U.S.C. §119 to Korean Patent Application No. 10-2008-0131285, filed on Dec. 22, 2008, in the Korean Intellectual Property Office, the disclosure of which is incorporated herein by reference in its entirety.

### TECHNICAL FIELD

The following disclosure relates to a distributed index system and method based on multi-length signature files, and in particular, to a distributed index system and method based on multi-length signature files, capable of supporting an efficient search on high-capacity high-dimensional data under a cluster environment.

### BACKGROUND

As the advance of computing and media technologies and the emergence of web 2.0, Internet service paradigm has shifted from provider-oriented service to user oriented service. Thus, the amount and use of multimedia data such as user created contents (UCC) are on the rapid increase in Internet services. Hence, there arises a content-based search problem that finds images or moving pictures on the basis of images or moving pictures belonging to users. To solve this problem, methods have been proposed, which analyze multimedia data such as images, audios or videos, convert the analyzed multimedia data into high-dimensional feature vectors, establish indices thereof, and find similarity between the high-dimensional data.

Indexing studies for supporting content-based search on high-dimensional data may be classified into tree-based indexing scheme and a filtering-based indexing scheme.

The tree-based indexing scheme is to partition a data space like K-D-B tree or Quad tree, or cluster scattered data like R-tree, X-tree or M-tree, and use rectangles or circles representing a cluster of neighbor objects as a search unit. However, the increase of data dimension expands an overlap area between the rectangles or circles representing the cluster of the neighbor objects. Thus, the search performance is exponentially degraded. In the worst cases, the search performance may be lower than that of a sequential search. This phenomenon is known as a dimensional curse. Therefore, there is a need for methods and systems that can solve the dimension curse problem.

The filtering-based indexing scheme (for example, VA-File, CBF, and so on) is to partition a data space for each dimension, allocate bits, and use the allocated bits as an abstract value (signature, approximation) of a vector. The filtering-based indexing scheme prunes unnecessary data through a sequential search of the generated signature, thereby improving a search performance of a range query or k-nearest neighbor search on high-dimensional data.

Unlike the tree-based indexing scheme, the filtering-based indexing scheme is not greatly influenced by the increase of dimension, but the load of the sequential search increases as the data increases.

Therefore, in the filtering-based indexing scheme, the bit length for signature is an important factor in determining the size of data to be read and the accuracy of the search. That is, as the bit length for signature is larger, the filtering object increases and thus the accuracy increases, whereas the size of the signature to be searched increases. However, most of the existing filtering-based indexing schemes do not consider distribution information on target data in determining the bit length for signature expression.

That is, as illustrated in FIG. 2, in the similarity search such as a range query or k-nearest neighbor search on high-dimensional data, feature vectors of objects within clusters 200, 210, 220 and 250 can obtain a filtering effect by conversion into a signature constituted with 2 bits per dimension.

However, feature vectors of objects contained in clusters 230 and 240 having a smaller cluster size than other clusters cannot obtain a filtering effect from 2-bit signature because all feature vectors are contained in one cell. That is, the clusters 230 and 240 having the small cluster size can expect the performance improvement through the filtering during the similarity search only when the feature vectors are expressed with signatures having bit length longer than 2 bits per dimension. However, if the signature of the cell constituted by partitioning an N-dimensional data space into uniform sub-spaces replaces the feature vectors of all objects contained in the cell, the search function is degraded by signatures that do not reflect the distribution information of the feature vectors into the high-dimensional space. As high-dimensional data to be searched becomes high-capacity, the difference of the search performance also increases.

Meanwhile, as the multimedia services have been regarded as next-generation Internet services, multimedia data are exponentially increased. Hence, it is difficult to index the high-dimensional index with respect to several billions of multimedia objects at a single computing node. As an indexing structure for supporting high scalability under the cluster environment, the tree-based indexing scheme may divide data by sub trees and store them in several nodes in a distributed manner. However, the tree-based indexing scheme is not effective because its search performance is inferior to the performance of the sequential search as the dimension of data increases. Since the filtering-based indexing scheme searches entire signature files in sequence, it has a problem that causes a whole search in parallel at each node even though signature files are stored in a separated and distributed manner. That is, the existing high-dimensional data indexing scheme has inferior performance in high-capacity high-dimensional data search because it has no serious consideration for the cluster computing environment and parallel processing.

### SUMMARY

In one general aspect, a distributed index system based on multi-length signature files includes: a feature vector extracting unit extracting N-dimensional feature vectors from multimedia object and identifier; a high-dimensional index unit establishing a tree-based distributed index according to the N-dimensional feature vectors and the identifier of the multimedia object, determining a signature length by comparing number of leaf nodes of the established distributed index tree and a reference cluster size, and a high-dimensional index managing unit generating signatures for each leaf node, on which the determined length is reflected, storing the generated signatures with matching to the N-dimensional feature vectors.

In another general aspect, a distributed index method based on multi-length signature files includes: extracting N-dimensional feature vectors from multimedia object; establishing a tree-based distributed index through a random sampling from the extracted N-dimensional feature vectors; calculating a cluster size for each leaf node of the established distributed index tree, and determining a signature length according to the calculated cluster size; determining a computing node for each leaf node of the distributed index tree; and generating signatures having the determined length at the computing node and storing the generated signatures with matching to the N-dimensional feature vectors.

In another general aspect, a distributed index method based on multi-length signature files includes: extracting feature vectors from a stored multimedia object; searching a distributed index tree based on the extracted feature vectors, determining candidate leaf nodes having a similar value, and requesting a similarity search; generating signatures managed at the candidate leaf nodes determined upon the similarity search request, and determining candidate signatures by sequentially searching stored signature files based on the generated signatures; and searching feature vectors corresponding to the candidate signatures determined at the candidate leaf nodes, and determining final candidate feature vectors.

Other features and aspects will be apparent from the following detailed description, the drawings, and the claims.

### BRIEF DESCRIPTION OF THE DRAWINGS

FIG. 1 is a block diagram of a distributed index system based on multi-length signature files according to an exemplary embodiment.

FIG. 2 illustrates a two-dimensional feature vector space, which is partitioned and represented by signatures of 2 bits per dimension.

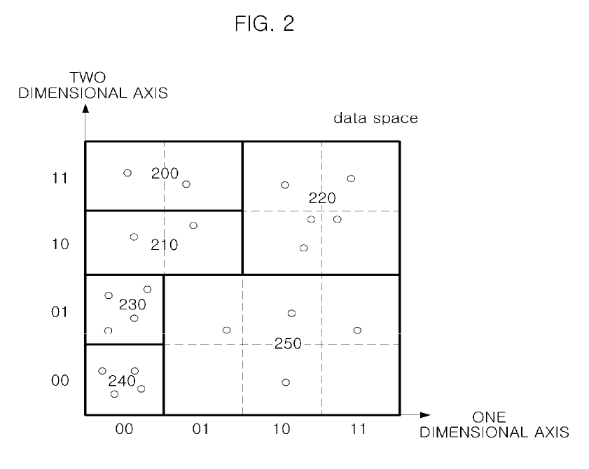

FIG. 3 illustrates a structure of a tree-based distributed index, where data distribution is considered, according to an exemplary embodiment.

FIG. 4 illustrates a tree structure for high-capacity high-dimensional data index according to an exemplary embodiment.

FIG. 5 is a flowchart illustrating a setting procedure for a distributed index search based on multi-length signature files according to an exemplary embodiment.

FIG. 6 is a flowchart illustrating a procedure for a distributed index search based on multi-length signature files according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

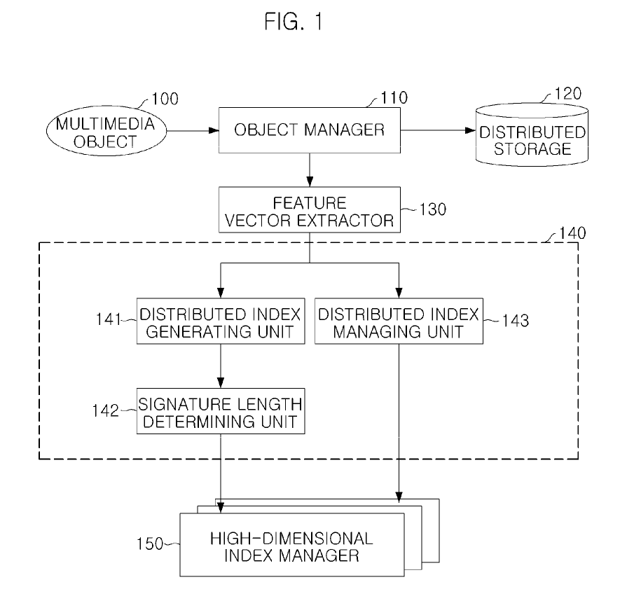

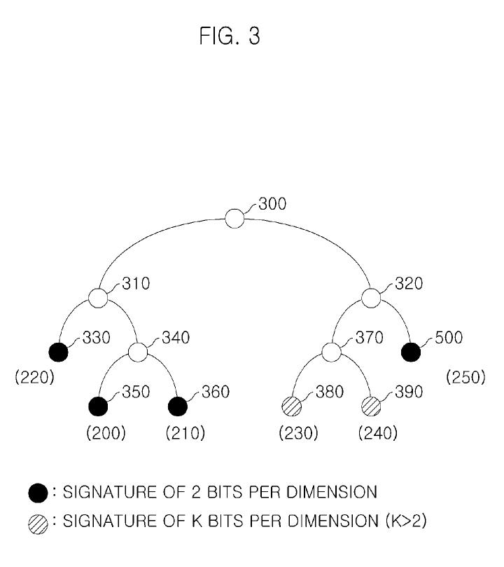

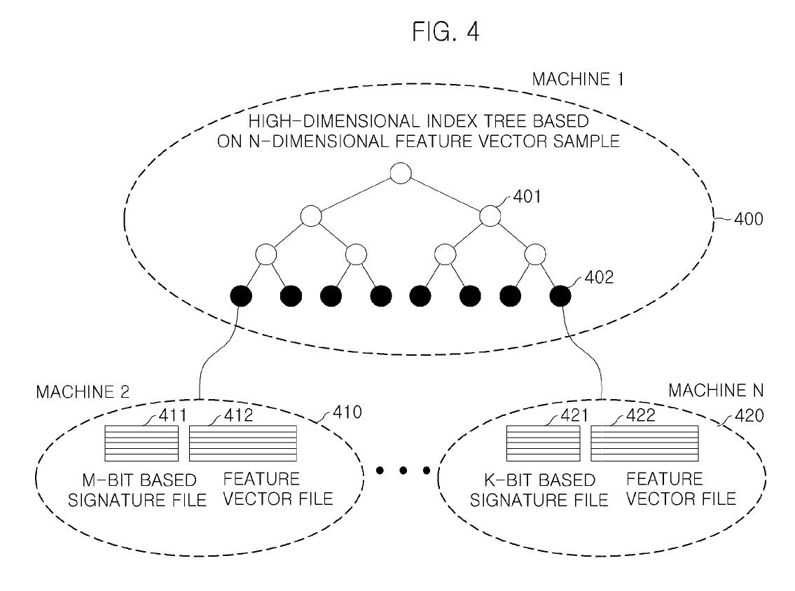

FIG. 1 is a block diagram of a distributed index system based on multi-length signature files according to an exemplary embodiment, FIG. 3 illustrates a structure of a tree-based distributed index, where data distribution is considered, according to an exemplary embodiment, and FIG. 4 illustrates a tree structure for high-capacity high-dimensional data index according to an exemplary embodiment.

Referring to FIG. 1, the distributed index system according to the exemplary embodiment includes an object manager 110, a distributed storage 120, a feature vector extractor 130, a high-dimensional indexer 140, and a high-dimensional index manager 150.

The object manager 110 extracts object identifier from multimedia objects of incoming audios, moving pictures or images, and manages storing of multimedia object information.

The distributed storage 120 individually stores information on the multimedia object 100.

The feature vector extractor 130 extracts N-dimensional feature vectors from the multimedia object 100 and identifier.

The high-dimensional indexer 140 includes a distributed index generating unit 141, a signature length determining unit 142, and a distributed index managing unit 143.

As illustrated in FIG. 3, the distributed index generating unit 141 indexes a two-dimensional feature vector space into a tree structure by randomly sampling as many feature vectors as receivable in one node within a cluster computing environment from the N-dimensional feature vectors. The established tree may be a tree that partitions the feature vector space, like M-tree, SP-tree, or Hybrid-tree. As illustrated in FIG. 4, the sampled feature vectors may construct non-leaf node 401 and serve as a routing node that determines a search inside the tree.

The signature length determining unit 142 calculates a cluster size corresponding to a leaf node of the tree. In this case, the signature length determining unit 142 calculates a distance from the center point of the feature vector space corresponding to the leaf node to the cluster boundary, or calculates the farthest distance within the feature vector space corresponding to the leaf node.

In addition, the signature length determining unit 142 determines the signature length by comparing the calculated cluster size with the reference cluster size defined by the user. Specifically, the signature length determining unit 142 determines the signature length by comparing the entire data space size with the reference cluster size where the number of leaf nodes of the distributed index tree is reflected.

In this case, the signature length is determined according to the data distribution. The reference cluster size is determined based on the entire feature vector size, the number of leaf nodes, the cluster size of each leaf node, and the number of lists of the number of bits to be used.

The distributed index manager 143 searches the distributed index tree through the object identifier and the N-dimensional feature vectors, and requests to store the object identifier and the feature vector in the corresponding node. Also, the distributed index manager 143 searches the distributed index tree based on the extracted feature vector from the multimedia object 100 by the feature vector extractor 130, determines candidate leaf nodes having a similar value, and requests a similarity search.

As illustrated in FIG. 4, upon the input of the storing request, the high-dimensional index manager 150 determines computing nodes 410 and 420 to divide and store the feature vectors for each leaf node within the distributed index tree in a distributed manner, generates signatures for each specific length managed at the corresponding nodes, and stores the generated signatures in the determined computing nodes 410 and 420 with matching to the N-dimensional feature vectors.

Therefore, as illustrated in FIG. 3, if the size of the cluster corresponding to the leaf node of the distributed index tree is equal to or larger than the data space in the case where the two-dimensional data space is partitioned into 6 equal portions, which is the number of leaf nodes, the corresponding leaf nodes 330, 350, 360 and 500 use signatures of 2 bits per dimension. If not, the leaf nodes 380 and 390 of the tree corresponding to the clusters 230 and 240 can obtain a filtering effect when searching high-dimensional data through conversion into signatures of k-bits, which is larger than 2 bits per dimension.

Furthermore, the high-dimensional index manager 150 generates signatures managed at the determined candidate leaf nodes, determines candidate signatures by sequentially searching the stored signature files stored based on the generated signatures, and determines final candidate feature vectors by searching the feature vectors of the candidate signatures.

In this case, when there are more than one candidate leaf nodes, the final feature vector is determined by combining the final candidate feature vectors determined at each candidate leaf node.

Meanwhile, the high-dimensional index manager 150 is disposed on a computing node different from the distributed index generating unit 141, the signature length determining unit 142 and the distributed index managing unit 143 of the high-dimensional indexer 140.

The distributed index generating unit 141 and the distributed index managing unit 143 of the high-dimensional indexer 140 can separate and combine the functions according to the entire data space size and the data distribution.

The operation of the distributed index system according to the exemplary embodiment will be described below with reference to the accompanying drawings.

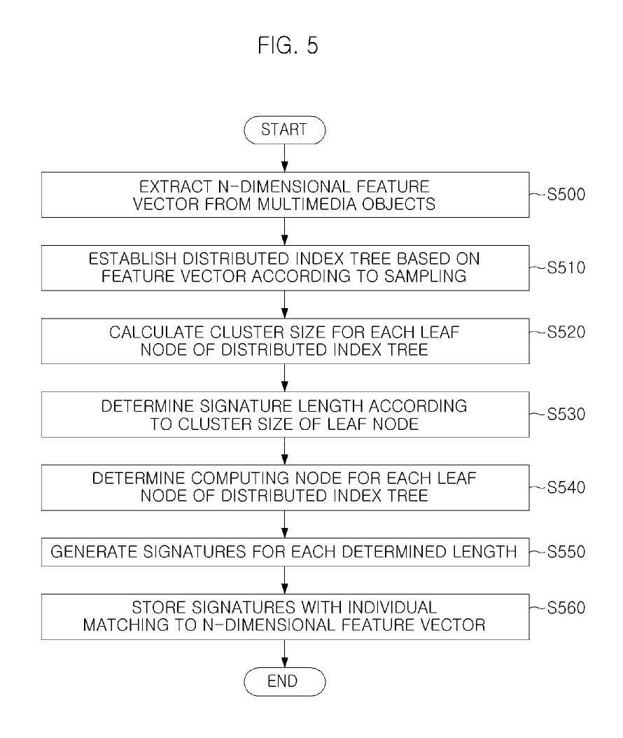

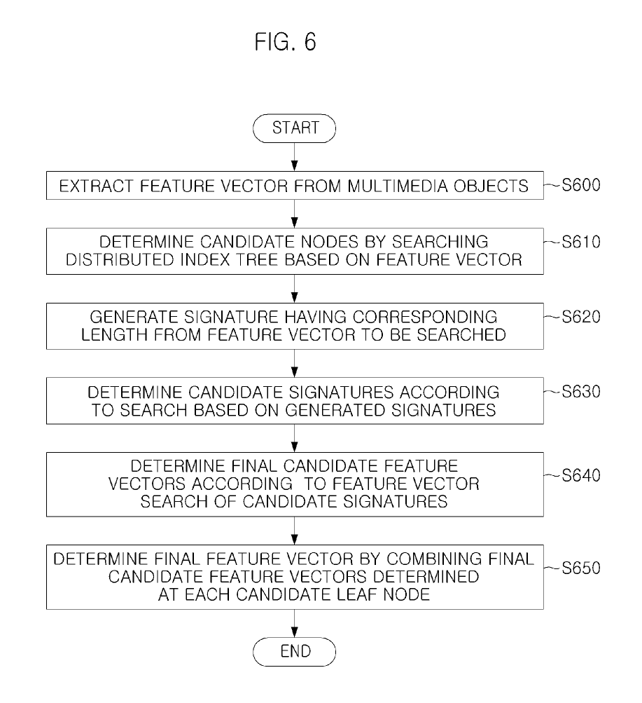

FIG. 5 is a flowchart illustrating a setting procedure for a distributed index search based on multi-length signature files according to an exemplary embodiment, and FIG. 6 is a flowchart illustrating a procedure for a distributed index search based on multi-length signature files according to an exemplary embodiment.

Referring to FIG. 5, N-dimensional feature vectors are extracted from multimedia objects of moving pictures or images in step S500.

Then, tree-based distributed indices are established in step S510 through a random sampling at the N-dimensional feature vectors extracted in step S500.

Next, the cluster sizes for each leaf node of the distributed index tree established in step S510 are calculated in step S520. In step S530, the signature length to be established at the leaf node is determined by comparing the calculated cluster size for each leaf node with the reference cluster size determining the number of bits for signature. In this case, the reference cluster size is determined based on the entire feature vector size, the number of the leaf nodes, the cluster size of each leaf node, and number of lists of the number of bits to be used.

For example, the list of each reference cluster size and the list of the number of bits per dimension for each reference cluster (the number of lists of the number of bits=the number of lists about the cluster size+1, herein the number of bits of the last list is set to be the largest) are previously set. Assuming that the cluster size is inversely proportional to the number of bits per dimension, a distance from the center point of the feature vector space corresponding to the leaf node to the cluster boundary, or the farthest distance within the feature vector space corresponding to the leaf node is calculated. The number of bits of the first reference cluster smaller than the cluster size of the leaf node is determined as the number (length) of bits for the signatures to be used in the corresponding leaf node by comparing the calculated cluster size of the leaf node with the reference cluster size sorted in descending order (in order of magnitude).

In case where only the list of the number of bits for the signatures is set, if data are dispersed in a normal distribution, an average cluster size (avgs) is calculated by using the number of leaf nodes (nodeN) within the established distributed index tree and the entire feature vector space size (totalS) (avgs=totalS/nodeN). The cluster size to allocate the number of bits is calculated through the calculated average cluster size and the list of the number of bits per dimension for the signatures sorted in ascending order, and the signature length is determined based on the calculated cluster size.

In this case, if the calculated cluster size is larger than the average cluster size (avgS), the number of bits with a smaller length is allocated as one time, two times, and so on of the average cluster size (Equation (1)). If it is smaller than the average cluster size (avgS), the number of bits with a smaller length is allocated in order of one time, two times, and so on of the resulting value obtained by dividing the average cluster size by the number of the remaining bit lists (Equation (2)).

avgS×(upperN+1−i) (1)

where

$$upperN ( = \frac{bitN}{2} )$$

is the number of bit list to be allocated to the cluster that is larger than avgS, and 1<=i<=upperN, bitN(the number of the entire bit lists).

$$\frac{avgS}{lowerN} \times ( bitN - i ) \qquad ( 2 )$$

where

$$lowerN ( = \frac{bitN}{2} )$$

is the number of bit list to be allocated to the cluster that is smaller than avgS, and upperN<i<bitN(the number of entire bit lists).

Following step S530, the computing node separating and storing the feature vector for each leaf node of the distributed index tree in a distributed manner is determined in step S540.

Then, the signatures for each determined length are generated in step S550, and the signatures are stored in step S560 with individual matching to the N-dimensional feature vectors. That is, each dimension is divided into 2^{b} intervals according to the determined number of bits b, and signatures corresponding to the feature vectors are generated.

Since the determined computing node has a similar number of data but a size of data category of the corresponding feature vector may be different, signatures having a different length with respect to the feature vectors distributed and separately stored are generated and stored in parallel. Thus, the entire data space is further sub-divided only for the leaf node of the distributed index tree where the data within the small data category are clustered, thereby enhancing the filtering effect and the entire search performance.

Meanwhile, as illustrated in FIG. 6, when the setting operation for the distributed index search is completed, the feature vector is extracted from the multimedia object 100 in step S600. Candidate leaf nodes having similar values are determined by searching the distributed index tree according to the extracted feature vector in step S610. The determined candidate leaf nodes may be one or more leaf nodes according to the determination of the leaf nodes of the distributed index tree.

In step S620, signatures having the corresponding length are generated from the feature vectors to be searched at the candidate leaf nodes determined in step S610.

In step S630, candidate signatures are determined by sequentially searching the stored signature files managed at the candidate leaf nodes with reference to the signatures generated in step S620.

Then, the final candidate feature vectors are determined by searching the feature vectors corresponding to the candidate signatures determined at the candidate leaf nodes in step S640,.

When one or more candidate leaf nodes are determined, the final feature vector is determined by combining the final candidate feature vectors determined at each candidate leaf node in step S650.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A distributed index system based on multi-length signature files, the distributed index system comprising:
a feature vector extracting unit extracting N-dimensional feature vectors from multimedia object and identifier;
a high-dimensional index unit establishing a tree-based distributed index according to the N-dimensional feature vectors and the identifier of the multimedia object, and determining a signature length by comparing number of leaf nodes of the established distributed index tree and a reference cluster size; and
a high-dimensional index managing unit generating signatures for each leaf node, on which the determined length is reflected, and storing the generated signatures with matching to the N-dimensional feature vectors.

2. The distributed index system of claim 1, further comprising:
an object managing unit extracting an object identifier from the multimedia object and managing storing of information on the multimedia object; and
a distributed storing unit separately storing the information on the multimedia object.

3. The distributed index system of claim 1, wherein the reference cluster size is determined based on an entire feature vector size, number of leaf nodes, a cluster size of each leaf node, and number of lists of number of bits to be used.

4. The distributed index system of claim 1, wherein the high-dimensional index unit searches the distributed index tree based on the extracted feature vectors from the multimedia object, and requests a similarity search by determining candidate leaf nodes having a similar value.

5. The distributed index system of claim 1, wherein the high-dimensional index unit comprises:
a distributed index generating unit establishing a tree-based distributed index by extracting a random sample of N-dimensional feature vectors receivable in one computer among the N-dimensional feature vectors;
a signature length determining unit calculating a cluster size corresponding to a leaf node of the established tree, comparing the calculated cluster size with a reference cluster size defined by a user, and determining a signature length defined by the user; and
a distributed index managing unit searching the established distributed index tree by using the object identifier and the N-dimensional feature vectors, and requesting to store the object identifier and the feature vectors in the corresponding node.

6. The distributed index system of claim 5, wherein the signature length determining unit determines the signature length by comparing an entire data space size with the reference cluster size, on which the number of leaf nodes of the distributed index tree is reflected.

7. The distributed index system of claim 5, wherein, when calculating specific leaf nodes within the established distributed index tree, the signature length determining unit calculates a distance from a center point of a feature vector space corresponding to the leaf node to a cluster boundary, or calculates a farthest distance within the feature vector space corresponding to the leaf node.

8. The distributed index system of claim 5, wherein the signature length determining unit determines the signature length according to data distribution.

9. The distributed index system of claim 5, wherein the signature length determining unit compares the calculated cluster size of the leaf nodes with the reference cluster size sorted in descending order, and determines the number of bits of the first reference cluster, which is smaller than the cluster size of the leaf node, as the signature length to be used at the corresponding leaf node; or
the signature length determining unit calculates an average cluster size, calculates the cluster size, to which the number of bits is allocated through the calculated average cluster size and a list of the number of bits per dimension for signatures sorted in ascending order, and determines the signature length.

10. The distributed index system of claim 5, wherein the distributed index managing unit determines candidate leaf nodes having a similar value by searching the distributed index tree based on the extracted feature vectors from multimedia objects.

11. The distributed index system of claim 1, wherein the high-dimensional index managing unit generates signatures managed at the determined candidate leaf nodes upon search request, determines candidate signatures by sequentially searching stored signature files based on the generated signatures, searches feature vectors of the candidate signatures, and determines final candidate feature vectors.

12. The distributed index system of claim 1, wherein a signature length at a specific leaf node of the established distributed index tree is equal to or different from a signature length managed at another leaf node.

13. The distributed index system of claim 5, wherein the high-dimensional index managing unit is established on a computing node different from the distributed index generating unit, the signature length determining unit, and the distributed index managing unit.

14. A distributed index method based on multi-length signature files, the distributed index method comprising:
extracting N-dimensional feature vectors from multimedia object;
establishing a tree-based distributed index through a random sampling from the extracted N-dimensional feature vectors;
calculating a cluster size for each leaf node of the established distributed index tree, and determining a signature length according to the calculated cluster size;
determining a computing node for each leaf node of the distributed index tree; and
generating signatures having the determined length at the computing node and storing the generated signatures with matching to the N-dimensional feature vectors.

15. The distributed index method of claim 14, wherein the signature length is determined by calculating a distance from a center point of a feature vector space corresponding to the leaf node to a cluster boundary, or by calculating a farthest distance within the feature vector space corresponding to the leaf node.

16. The distributed index method of claim 14, wherein the signature length is determined by comparing an entire data space size with a reference cluster size, on which the number of leaf nodes of the distributed index tree is reflected.

17. The distributed index method of claim 16, wherein the reference cluster size is determined based on an entire feature vector size, number of leaf nodes, a cluster size of each leaf node, and number of lists of number of bits to be used.

18. The distributed index method of claim 16, wherein the signature length is determined according to data distribution.

19. A distributed index method based on multi-length signature files, the distributed index method comprising:
extracting feature vectors from a stored multimedia object;
searching a distributed index tree based on the extracted feature vectors, determining candidate leaf nodes having a similar value, and requesting a similarity search;
generating signatures managed at the candidate leaf nodes determined upon the similarity search request, and determining candidate signatures by sequentially searching stored signature files based on the generated signatures; and
searching feature vectors corresponding to the candidate signatures determined at the candidate leaf nodes, and determining final candidate feature vectors.

20. The distributed index method of claim 19, wherein, when one or more candidate leaf nodes are determined, a final feature vector is determined by combining the final candidate feature vectors determined at the candidate leaf nodes.
